(19) United States
(12) Patent Application Publication
(10) Pub. No.: US 2013/0106727 A1
(43) Pub. Date: May 2, 2013

(54) TOUCH SENSING DEVICE AND FABRICATION METHOD THEREOF

(71) Applicants: Yi-Chung Juan, Tainan (TW); Hsuan-Chen Liu, Kaohsiung (TW); Chang-Ching Yeh, Kaohsiung (TW); Sung-Chun Lin, Tainan (TW)

(72) Inventors: Yi-Chung Juan, Tainan (TW); Hsuan-Chen Liu, Kaohsiung (TW); Chang-Ching Yeh, Kaohsiung (TW); Sung-Chun Lin, Tainan (TW)

(21) Appl. No.: 13/403,598

(22) Filed: Feb. 23, 2012

(30) Foreign Application Priority Data
Oct. 27, 2011 (TW) 100139057

(51) Int. Cl. G06F 3/041; B05D 5/12

(52) U.S. Cl. 345/173; 427/77

(57) ABSTRACT

A touch sensing device is disclosed. The device includes a transparent substrate having a sensing region and a non-sensing region enclosing the sensing region. A sensing structure is disposed on the transparent substrate in the sensing region. A shielding layer is disposed on the transparent substrate in the non-sensing region and exposes the sensing region. A specific pattern layer is disposed between the transparent substrate and the shielding layer and has a specific pattern, such that the shielding layer above the specific pattern layer has a first thickness and the shielding layer outside of the specific pattern layer has a second thickness greater than the first thickness. A passivation layer covers the sensing structure and the shielding layer. A method for fabricating the touch sensing device is also disclosed.

### CROSS REFERENCE TO RELATED APPLICATIONS

This application claims priority of Taiwan Patent Application No. 100139057, filed on Oct. 27, 2011, the entirety of which is incorporated by reference herein.

### BACKGROUND OF THE INVENTION

1. Field of the Invention

The invention relates to a decorative technology for electronic products, and in particular to a light shield or decorative film for a touch sensing device.

2. Description of the Related Art

Electronic products with a touch sensing device (e.g., portable personal computers, personal digital assistants (PDAs), tablet personal computers, digital cameras, mobile phones, and the like) are capable of conducting input functions by a finger, a stylus, a pen, or the like and have gained an increasing amount of attention and popularity. Companies typically like to make a light shield or decorative film logos in order to increase the brand identity of their products for consumers.

In general, an opaque layer (e.g., a black matrix (BM) material layer) is disposed at the peripheral region (i.e., the non-sensing region) adjacent to the sensing region of a touch sensing device for light shield and decoration. Currently, companies utilize a conventional black photoresist for formation of the opaque layer. In the formation of the light shield or decorative film, a halftone mask is usually used for defining the logo. However, companies have different respective logos. Moreover, a halftone mask is only used for the logo of one company. Namely, each company requires a respective halftone mask. As a result, the manufacturing cost of the touch sensing devices is increased, and thus it does not meet economic benefits.

Accordingly, there exists a need in the art for development of a touch sensing device, capable of mitigating or eliminating the deficiencies mentioned above.

### BRIEF SUMMARY OF THE INVENTION

A detailed description is given in the following embodiments with reference to the accompanying drawings. Touch sensing devices and methods for fabricating the same are provided. An exemplary embodiment of a touch sensing device comprises a transparent substrate having a sensing region and a non-sensing region enclosing the sensing region. A sensing structure is disposed on the transparent substrate in the sensing region. A shielding layer is disposed on the transparent substrate in the non-sensing region and exposes the sensing region. A specific pattern layer is disposed between the transparent substrate and the shielding layer and has a specific pattern, such that the shielding layer above the specific pattern layer has a first thickness and the shielding layer outside of the specific pattern layer has a second thickness greater than the first thickness. A passivation layer covers the sensing structure and the shielding layer.

An exemplary embodiment of a method for fabricating a touch sensing device comprises providing a transparent substrate having a sensing region and a non-sensing region enclosing the sensing region. A specific pattern layer is formed on the transparent substrate in the non-sensing region, wherein the specific pattern layer has a specific pattern. A shielding layer is formed on the transparent substrate in the non-sensing region, such that the shielding layer covers the specific pattern layer and exposes the sensing region, wherein the shielding layer above the specific pattern layer has a first thickness and the shielding layer outside of the specific pattern layer has a second thickness greater than the first thickness. At least one sensing unit is formed on the transparent substrate in the sensing region, wherein the sensing unit has a set of first sensing electrodes arranged along a first direction, a set of second sensing electrodes arranged along a second direction, and a connecting portion extending between the set of first sensing electrodes. A passivation layer covers the sensing unit and the shielding layer.

### BRIEF DESCRIPTION OF DRAWINGS

The invention can be more fully understood by reading the subsequent detailed description and examples with references made to the accompanying drawings, wherein:

FIGS. 1A to 1F are plan views of an embodiment of a method for fabricating a touch sensing device according to the invention;

FIGS. 2A to 2F are cross sections along the 2-2′ line shown in FIGS. 1A to 1F;

FIGS. 3A to 3F are plan views of another embodiment of a method for fabricating a touch sensing device according to the invention; and

FIGS. 4A to 4F are cross sections along the 4-4′ line shown in FIGS. 3A to 3F.

### DETAILED DESCRIPTION OF INVENTION

The following description is of the best-contemplated mode of carrying out the invention. This description is provided for the purpose of illustrating the general principles of the invention and should not be taken in a limiting sense. The scope of the invention is best determined by reference to the appended claims.

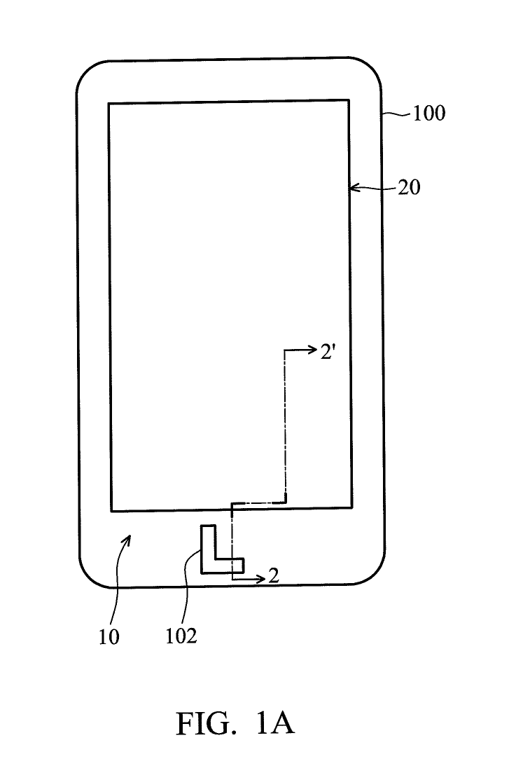

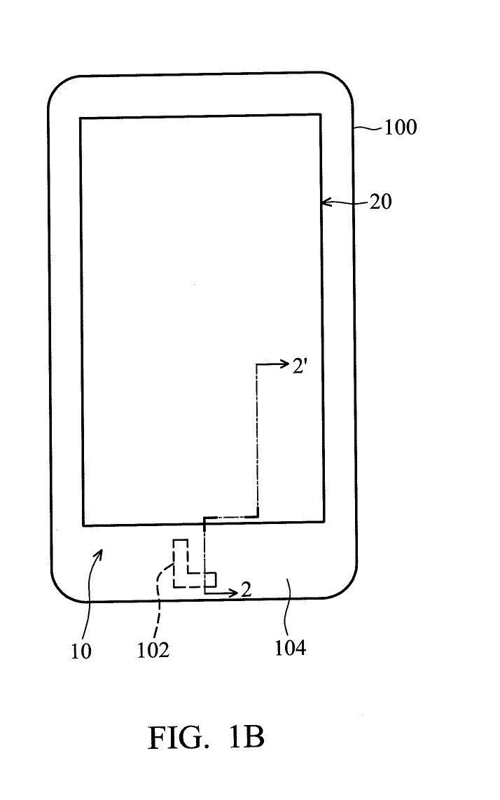

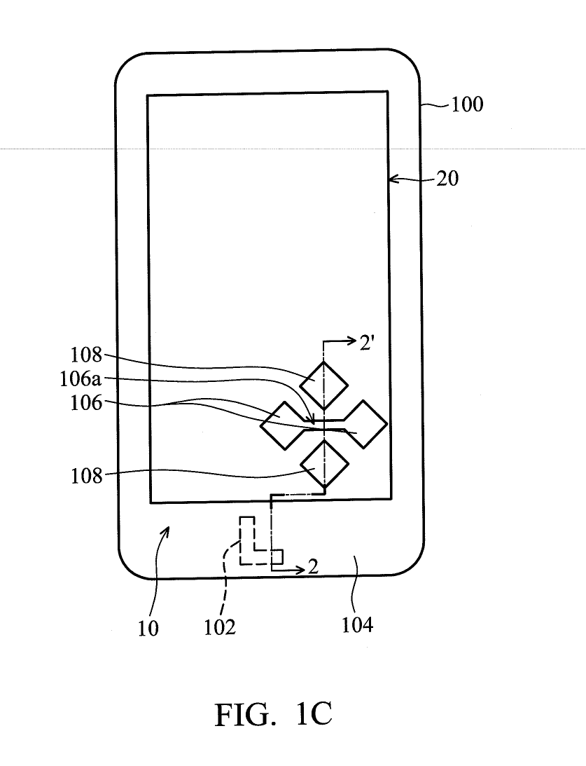

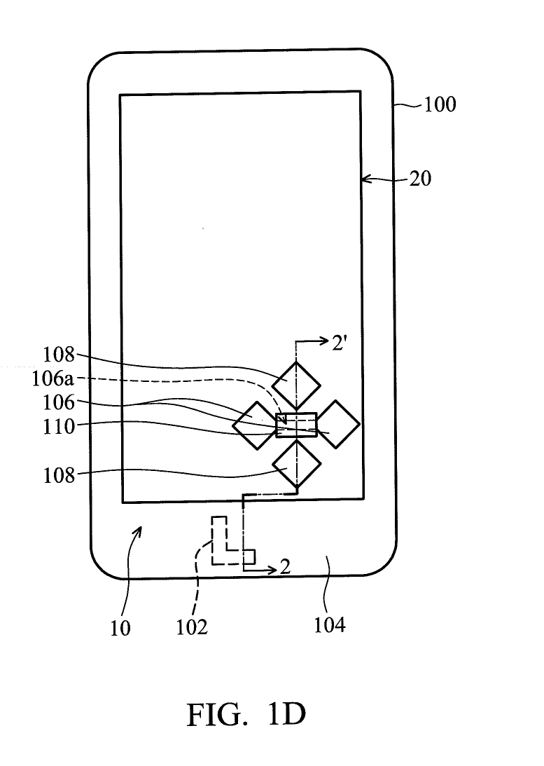

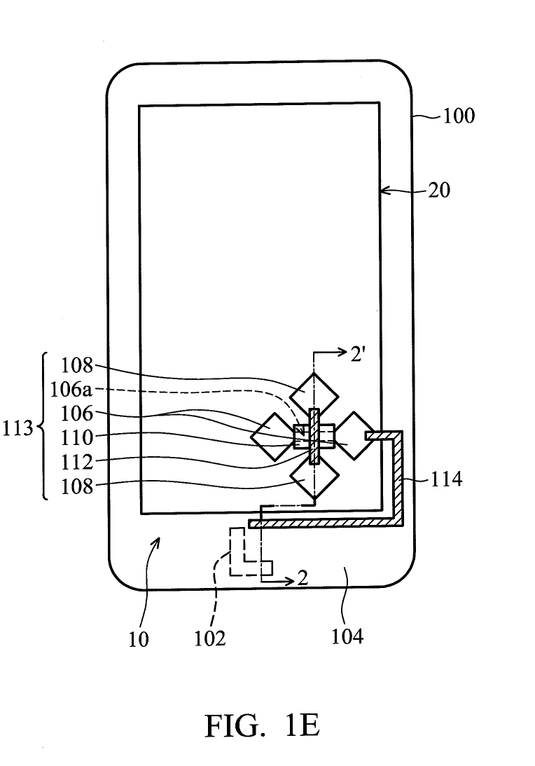

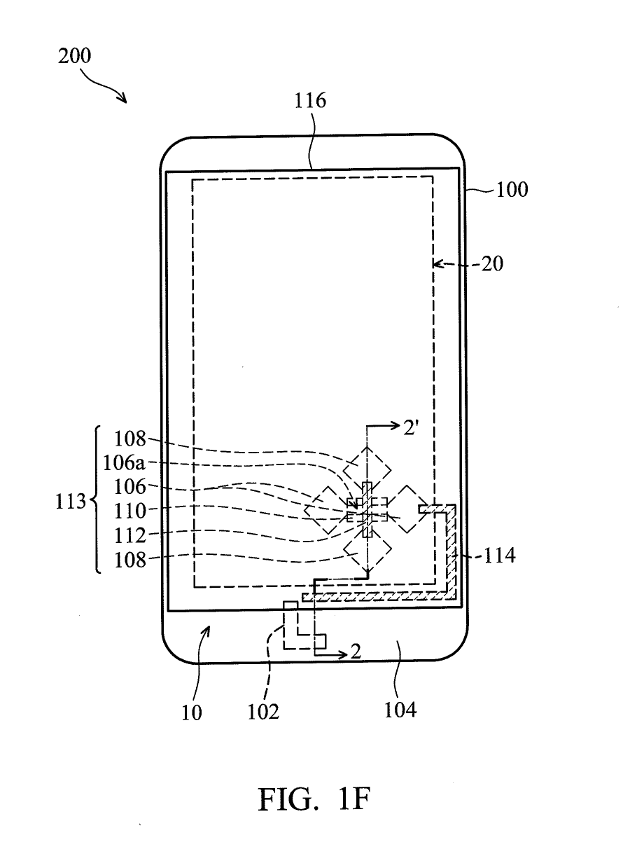

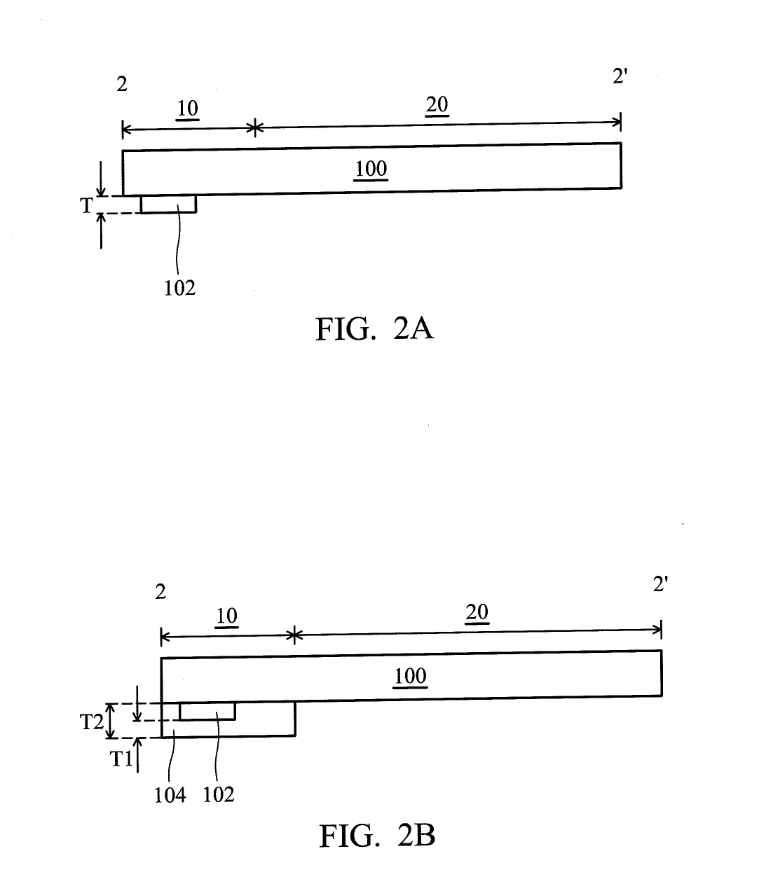

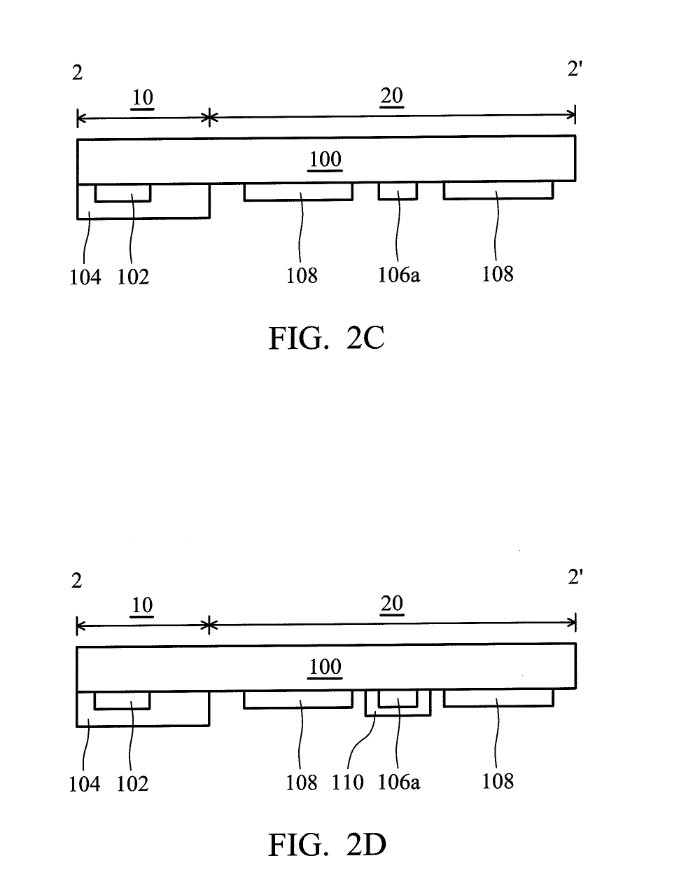

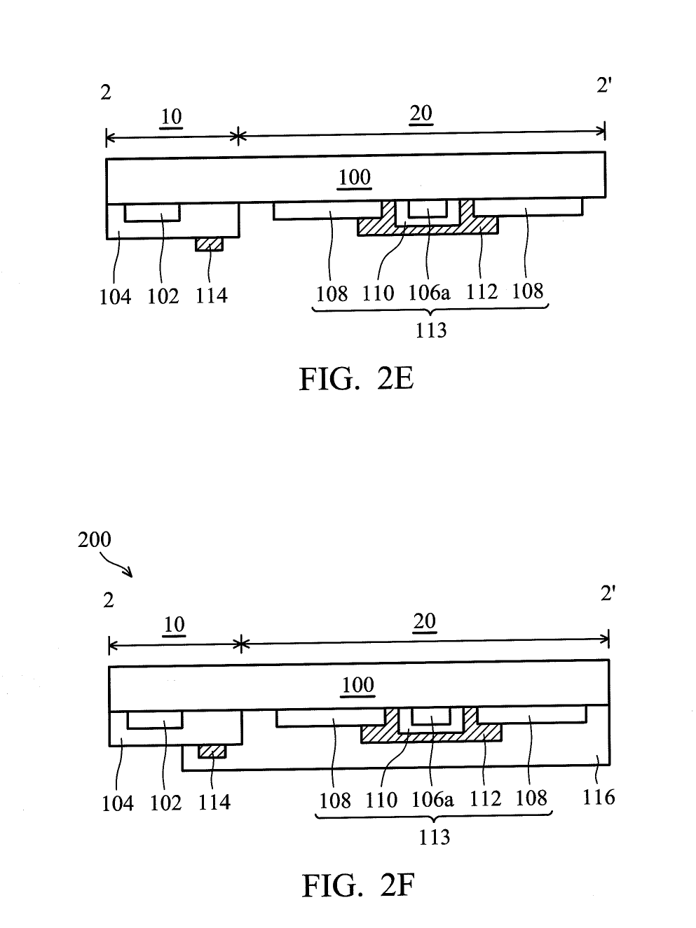

Referring to FIGS. 1F and 2F, in which FIG. 1F is a plan view of an embodiment of a touch sensing device 200 according to the invention and FIG. 2F is the cross section along 2-2′ line shown in FIG. 1F. In the embodiment, the touch sensing device 200 comprises a transparent substrate 100, a specific pattern layer 102, a shielding layer 104, a sensing structure 113 and a passivation layer 116. In one embodiment, the transparent substrate 100 may be comprised of glass, quartz, or other transparent materials, especially, tempered glass, thereby providing a sensing surface. The transparent substrate 100 has a sensing region 20 and a non-sensing region 10. Typically, the non-sensing region 10 is at the peripheral region of the transparent substrate 100 and encloses the sensing region 20.

The shielding layer 104 is disposed on the transparent substrate 100 in the non-sensing region 10 and exposes the sensing region 20, thereby serving as a light shielding or decorative layer for the touch sensing device 200. The shielding layer 104 may be comprised of BM or white photoresist material.

The specific pattern layer 102 is disposed between the transparent substrate 100 and the shielding layer 104, and has a predetermined thickness T (labeled in FIG. 2A), such that the shielding layer 104 on the specific pattern layer 102 has a first thickness T1 (labeled in FIG. 2B) and the shielding layer 104 outside of the specific pattern layer 102 has a second thickness T2 (labeled in FIG. 2B) greater than the first thickness T1. In the embodiment, the predetermined thickness T (i.e., the thickness of the specific pattern layer 102) is not greater than the second thickness T2. Moreover, the first thickness T1 has a range from 0 μm to 10 μm. As a result, the shielding layer 104 can be formed with different thicknesses without using a halftone mask due to the existence of the specific pattern layer 102. Accordingly, the shielding layer 104 is capable of generating various gray levels or colors. In the embodiment, the specific pattern layer 102 can be comprised of an organic material (e.g., photoresist material) or an inorganic material (e.g., SiNx and/or SiOx). Moreover, the specific pattern layer 102 has a specific pattern (e.g., a logo pattern “L” as shown in FIG. 1F). It is appreciated that the logo pattern “L” is merely an example, and the specific pattern layer 102 may have other logo patterns which are based on different designs.

In particular, since the shielding layer 104 may generate various gray levels or colors by the specific pattern layer 102, the logo pattern formed by the specific pattern layer 102 can be clearly observed by the user. Moreover, if the logo pattern requires various colors, transparent or colored photoresist can be used for the specific pattern layer 102, wherein the colored photoresist has a color different from that of the shielding layer 104.

The sensing structure 113 is disposed on the transparent substrate 100 in the sensing region 20. In the embodiment, the sensing structure 113 may comprise a plurality of sensing units. It can be understood that the plurality of sensing units is typically arranged in an array. Here, only one sensing unit is depicted for the purpose of brevity and clarity. The sensing unit (as shown in FIG. 1F) comprises a set of first sensing electrodes 106 arranged along a first direction (e.g., the horizontal direction), a set of second sensing electrodes 108 arranged along a second direction (e.g., the vertical direction) and a connecting portion 106a extending between the set of first sensing electrodes 106. The sensing unit may be comprised of a transparent conductive pattern layer, such as an indium tin oxide (ITO) or indium zinc oxide (IZO) layer.

Moreover, the sensing structure 113 may further comprise an isolation layer 110 and a bridge layer 112. The bridge layer 112 (which may be comprised of, for example, aluminum, chromium or the alloy thereof or other metals well known in the art) is electrically connected to the set of second sensing electrodes 108 along the second direction. The isolation layer 110 (e.g., an organic or inorganic material layer) is disposed between the connecting portion 106a and the bridge layer 112, such that the isolation layer 110 covering the connecting portion 106a is capable of being electrically insulated from the set of first sensing electrodes 106 and the set of second sensing electrodes 108.

The passivation layer 116 is disposed on the transparent substrate 100 in the sensing region 20 and a portion of the non-sensing region 10, to cover the sensing structure 113 and a portion of the shielding layer 104. In one embodiment, the passivation layer 116 may comprise an organic photoresist material, an inorganic dielectric material, or a transparent resin.

In the embodiment, the touch sensing device 200 may further comprise a plurality of traces (which may be comprised of, for example, aluminum, chromium or the alloy thereof or other metals well known in the art), wherein each of the plurality of traces is extended onto the shielding layer 104 from the corresponding sensing unit, and is covered by the passivation layer 116. The plurality of traces is used for electrically connecting the corresponding sensing unit to the exterior circuits (not shown). Here, in order to simplify the diagram, only one trace 114 is depicted.

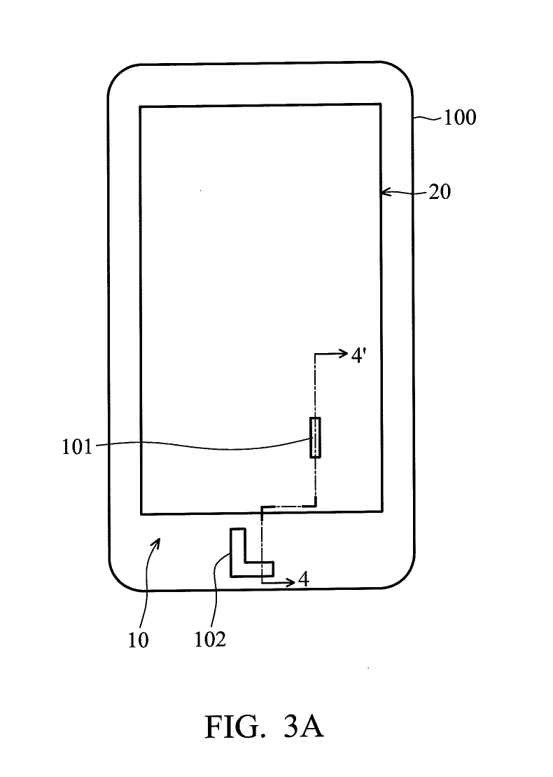

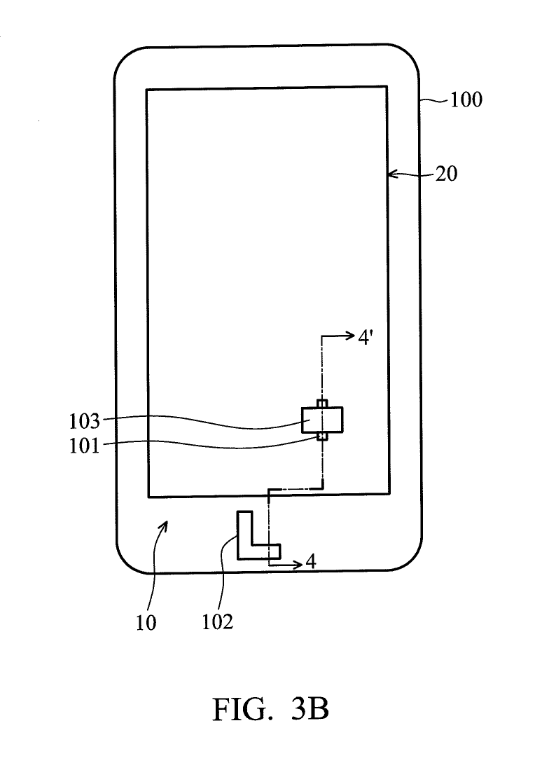

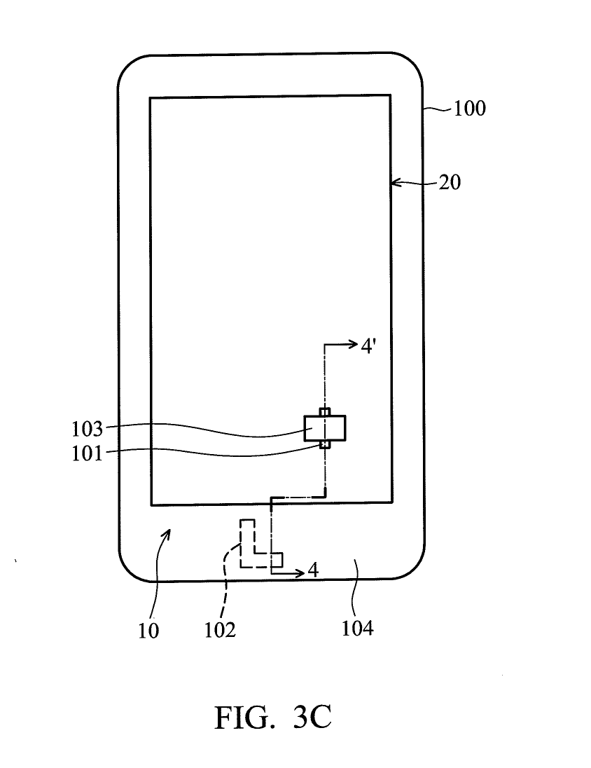

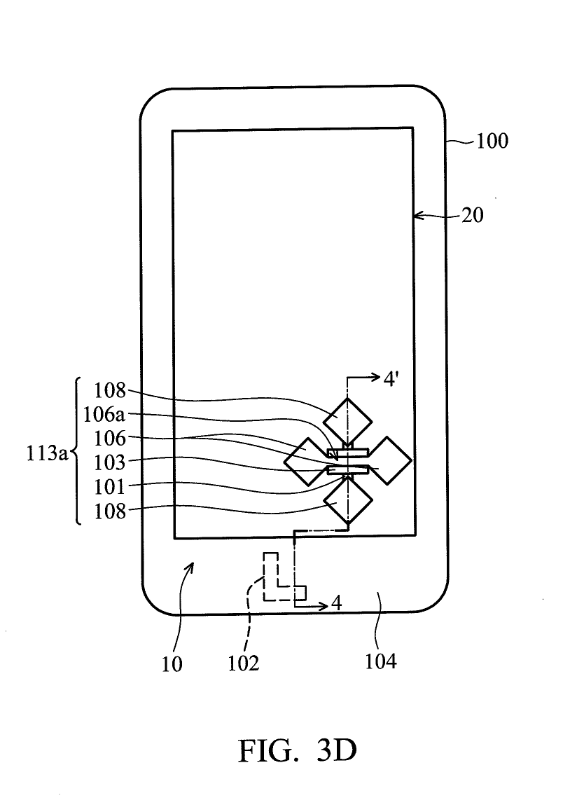

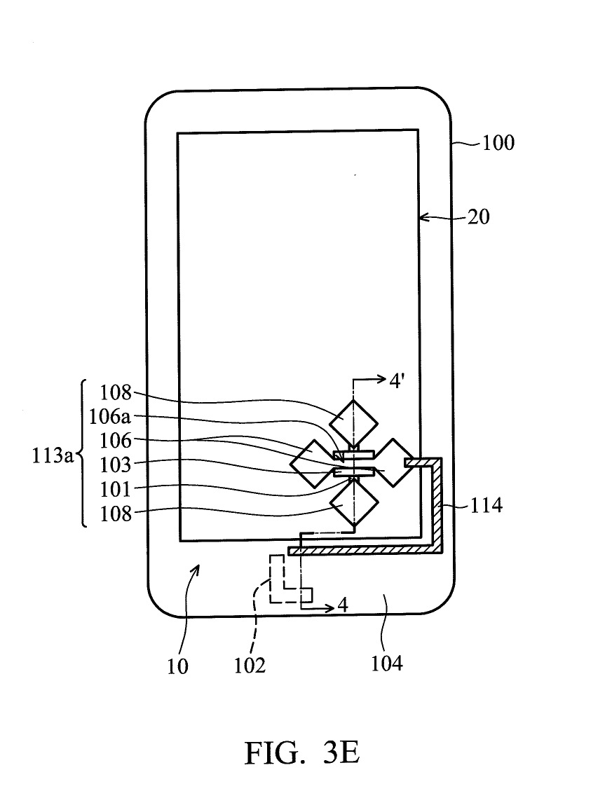

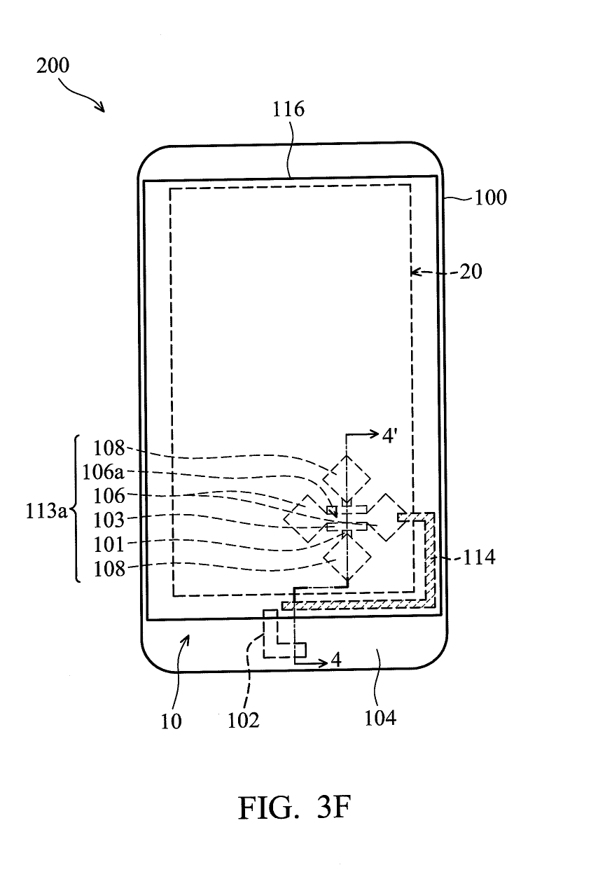

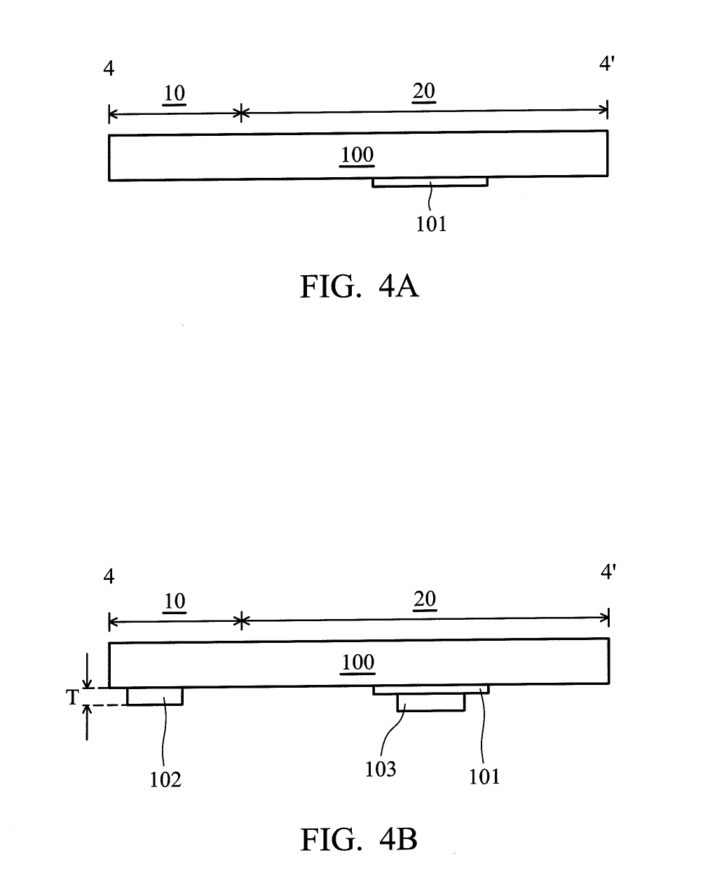

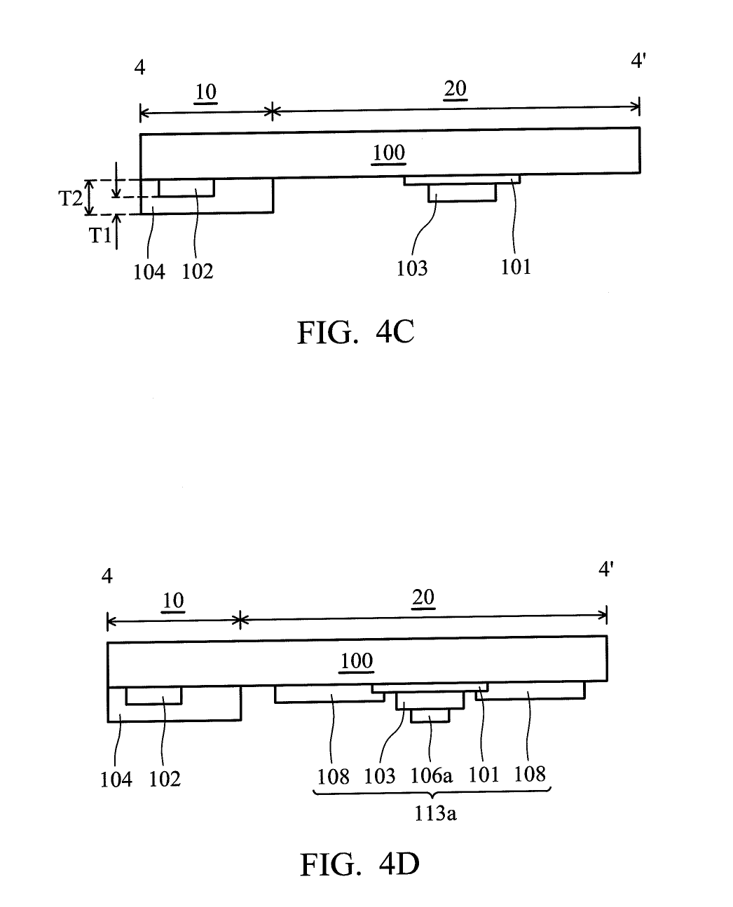

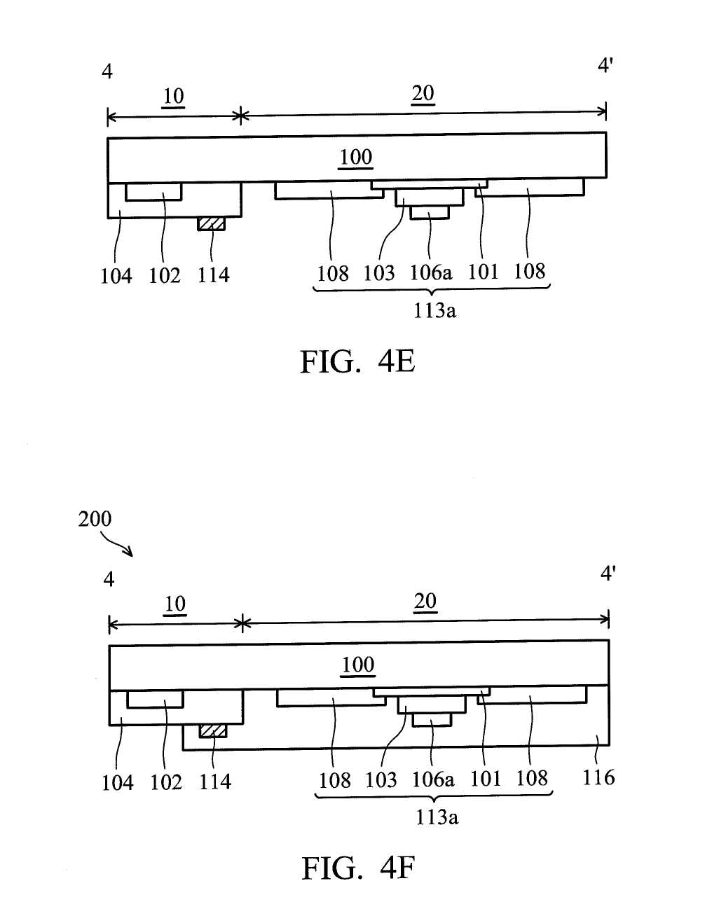

Referring to FIGS. 3F and 4F, in which FIG. 3F is a plan view of an embodiment of a touch sensing device 200 according to the invention and FIG. 4F is the cross section along 4-4′ line shown in FIG. 3F. Elements in FIGS. 3F and 4F that are the same as those in FIGS. 1F and 2F are labeled with the same reference numbers as in FIGS. 1F and 2F and are not described again for brevity. A sensing structure 113a of the touch sensing device 200 may comprise at least one sensing unit. In the sensing unit (as shown in FIG. 3F), the set of second sensing electrodes 108 covers a portion of a bridge layer 101, such that each of the set of second sensing electrodes 108 is electrically connected to each other. In the embodiment, the bridge layer 101 may be comprised of a transparent conductive material, such as ITO or IZO. Moreover, an isolation layer 103 covers a portion of the bridge layer 101, and the connecting portion 106a is disposed on the isolation layer 103, such that the isolation layer 103 between the connecting portion 106a and the bridge layer 112 is capable of being electrically insulated from the set of first sensing electrodes 106 and the set of second sensing electrodes 108. The isolation layer 103 and the specific pattern layer 102 may be comprised of the same insulating material.

Refer to FIGS. 1A to 1F and FIGS. 2A to 2F, in which FIGS. 1A to 1F are plan views of an embodiment of a method for fabricating a touch sensing device according to the invention, and FIGS. 2A to 2F are cross sections along the 2-2′ line shown in FIGS. 1A to 1F. Firstly, referring to FIGS. 1A and 2A, a transparent substrate 100, which may be comprised of glass, quartz, or other transparent materials, is provided. The transparent substrate 100 has a sensing region 20 and a non-sensing region 10 enclosing the sensing region 20. Next, a specific pattern layer 102 is formed on the transparent substrate 100 in the non-sensing region 10. The specific pattern layer 102 has a predetermined thickness T and has a specific pattern (e.g., a logo pattern “L”). In the embodiment, the specific pattern layer 102 may be formed by the patterning of an organic insulating material layer (e.g., a photoresist material layer) or an inorganic insulating material layer (e.g., SiNₓ and/or SiOₓ.

Referring to FIGS. 1B and 2B, a shielding layer 104 is formed on the transparent substrate 100 in the non-sensing region 10, such that the shielding layer 104 covers the specific pattern layer 102 and exposes the sensing region 20, thereby serving as a light shield/decorative film for a touch sensing device. The shielding layer 104 may be formed by patterning a BM material layer or a white photoresist layer using lithography and etching processes. Particularly, in the embodiment, the shielding layer 104 on the specific pattern layer 102 has a first thickness T1 and the shielding layer 104 outside of the specific pattern layer 102 has a second thickness T2 greater than the first thickness T1. Moreover, the predetermined thickness T is not greater than the second thickness T2. Refer to table 1, which shows the relationship among the first thickness T1, the optical density (OD), and the transmittance.

TABLE 1

| T1 (μm) | OD | Transmittance |
|---|---|---|
| 0 | 0 | 100% |
| 1 | 0.5 | 31.62% |
| 2 | 1 | 10.00% |
| 3 | 1.5 | 3.16% |
| 4 | 2 | 1.00% |
| 5 | 2.5 | 0.32% |
| 6 | 3 | 0.10% |
| 7 | 3.5 | 0.03% |
| 8 | 4 | 0.01% |

As shown in table 1, the transmittance may be increased to about 32% when the first thickness T1 is controlled to 1 μm. In the embodiment, the first thickness T1 can be controlled from a range of 0 μm to 10 μm. As a result, the shielding layer 104 can generate different gray levels or colors by itself due to the variation in thickness. Accordingly, the logo pattern from the specific pattern layer can be clearly observed by the user through the shielding layer 104. Moreover, if the logo pattern requires various colors, transparent or colored photoresist can be used for the specific pattern layer 102, wherein the colored photoresist has a color different from that of the shielding layer 104.

Referring to FIGS. 1C and 2C, a plurality of sensing units, which is arranged in an array, is formed on the transparent substrate 100 in the sensing region 20. Here, only one sensing unit is depicted for the purpose of brevity and clarity. The sensing unit may comprise a set of first sensing electrodes 106 arranged along a first direction (e.g., the horizontal direction), a set of second sensing electrodes 108 arranged along a second direction (e.g., the vertical direction) and a connecting portion 106a extending between the set of first sensing electrodes 106. The sensing unit may be formed by patterning the same transparent conductive pattern layer, such as an ITO or IZO layer, using lithography and etching processes.

Referring to FIGS. 1D and 2D, an isolation layer 110 is formed on the connecting portion 106a. In one embodiment, an organic or inorganic insulating layer (not shown) may be formed by a conventional deposition process, such as spin coating or chemical vapor deposition (CVD). Thereafter, the insulating layer is patterned by conventional lithography and etching processes, thereby forming an isolation layer 110 on the connecting portion 106a in the sensing region 20.

Referring to FIGS. 1E and 2E, a bridge layer 112 is formed on the isolation layer 110 along the second direction for electrical connection of the set of second sensing electrodes 108. In the embodiment, the sense unit (i.e., the set of first sensing electrodes 106, the set of second sensing electrodes 108 and the connecting portion 106a), the isolation layer 110 and the bridge layer 112 constitute a sensing structure 113.

Additionally, a plurality of traces may be formed while forming the bridge layer 112, wherein each of the plurality of traces is extended onto the shielding layer 104 from the corresponding sensing unit, thereby electrically connecting the corresponding sensing unit to exterior circuits (not shown). Here, in order to simplify the diagram, only one trace 114 is depicted. In one embodiment, the bridge layer 112 and the trace 114 may be comprised of metal, such as aluminum, chromium or the alloy thereof or other metals well known in the art.

Referring to FIGS. 1F and 2F, the sensing structure 113, the trace 114 and the shielding layer 104 are covered by a passivation layer 116, which completes the description of the touch sensing device 200. In one embodiment, the passivation layer 116 may comprise an organic photoresist material, an inorganic dielectric material or a transparent resin.

Refer to FIGS. 3A to 3F and FIGS. 4A to 4F, in which FIGS. 3A to 3F are plan views of an embodiment of a method for fabricating a touch sensing device according to the invention, and FIGS. 4A to 4F are cross sections along the 4-4′ line shown in FIGS. 3A to 3F. Elements in FIGS. 3A to 3F and FIGS. 4A to 4F that are the same as those in FIGS. 1A to 1F and FIGS. 2A to 2F are labeled with the same reference numbers as in FIGS. 1A to 1F and FIGS. 2A to 2F and are not described again for brevity. Firstly, referring to FIGS. 3A and 4A, a transparent substrate 100 having a sensing region 20 and a non-sensing region 10 enclosing the sensing region 20 is provided. Next, a bridge layer 101 is formed in the sensing region 20 along a predetermined direction (e.g., a vertical direction) for electrical connection of the set of second sensing electrodes formed in the subsequent steps. In the embodiment, the bridge layer 101 may be comprised of a transparent conductive material, such as ITO or IZO.

Referring to FIGS. 3B and 4B, a specific pattern layer 102 with a predetermined thickness T is formed on the transparent substrate 100 in the non-sensing region 10, wherein the specific pattern layer 102 has a specific pattern for a logo pattern. An isolation layer 103 may be formed on the bridge layer 101 while forming the specific pattern layer 102. For example, an organic or inorganic insulating material layer (not shown) is formed on the transparent substrate 100 by conventional deposition, such as spin coating or CVD, and covers a portion of the bridge layer 101. Thereafter, the insulating material layer is patterned by conventional lithography and etching processes, thereby forming the specific pattern layer 102 on the transparent substrate 100 in the non-sensing region 10 and forming the isolation layer 103 on the bridge layer 101. The isolation layer 103 is used for electrical insulation between the set of first sensing electrodes and the set of second sensing electrodes formed in the subsequent steps.

Referring to FIGS. 3C and 4C, a shielding layer 104 is formed on the transparent substrate 100 in the non-sensing region 10, such that the shielding layer 104 covers the specific pattern layer 102 and exposes the sensing region 20. The shielding layer 104 on the specific pattern layer 102 has a first thickness T1 and the shielding layer 104 outside of the specific pattern layer 102 has a second thickness T2 greater than the first thickness T1. Moreover, the predetermined thickness T is not greater than the second thickness T2. As a result, the shielding layer 104 is capable of generating various gray levels or colors with varying thickness thereof.

Referring to FIGS. 3D and 4D, a plurality of sensing units, which is arranged in an array, is formed on the transparent substrate 100 in the sensing region 20. Here, only one sensing unit is depicted for the purpose of brevity and clarity. Unlike the sensing unit shown in FIGS. 1C and 2C, in the embodiment, the set of second sensing electrodes 18 of the sensing unit partially covers the bridge layer 101, and the connecting portion 106a is formed on the isolation layer 103. Also, the bridge layer 101, the isolation layer 103 and the sensing unit (i.e., the set of first sensing electrodes 106, the set of second sensing electrodes 108 and the connecting portion 106a) constitute a sensing structure 113a.

Referring to FIGS. 3E and 4E, a plurality of traces is formed, wherein each of the plurality of traces is extended onto the shielding layer 104 from the corresponding sensing unit, thereby electrically connecting the corresponding sensing unit to exterior circuits (not shown). Here, in order to simplify the diagram, only one trace 114 is depicted.

Referring to FIGS. 3F and 4F, the sensing structure 113a, the trace 114 and the shielding layer 104 are covered by a passivation layer 116, which completes the description of the touch sensing device 200. In one embodiment, the passivation layer 116 may comprise an organic photoresist material, an inorganic dielectric material or a transparent resin.

According to the foregoing embodiments, since the specific pattern layer and the shielding layer can be formed using an ordinary mask in the lithography process, and the shielding layer with different thickness can be formed via the specific pattern layer, the manufacturing cost can be reduced compared to the conventional shielding layer with different thicknesses that are formed using a halftone mask, thereby increasing economic benefits. Additionally, since the specific pattern layer with a logo pattern can be formed of transparent or colored photoresist material, the logo pattern may have color diversity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch sensing device, comprising:
a transparent substrate having a sensing region and a non-sensing region enclosing the sensing region;
a sensing structure disposed on the transparent substrate in the sensing region;
a shielding layer disposed on the transparent substrate in the non-sensing region and exposing the sensing region;
a specific pattern layer disposed between the transparent substrate and the shielding layer and having a specific pattern, such that the shielding layer above the specific pattern layer has a first thickness and the shielding layer outside of the specific pattern layer has a second thickness greater than the first thickness; and
a passivation layer covering the sensing structure and the shielding layer.

2. The device as claimed in claim 1, wherein the sensing structure comprises:
at least one sensing unit having a set of first sensing electrodes arranged along a first direction, a set of second sensing electrodes arranged along a second direction, and a connecting portion extending between the set of first sensing electrodes;
a bridge layer electrically connected to the set of second sensing electrodes along the second direction; and
an isolation layer disposed between the connecting portion and the bridge layer.

3. The device of claim 2, wherein the isolation layer covers the connecting portion.

4. The device of claim 2, wherein the isolation layer covers the bridge layer.

5. The device of claim 4, wherein the isolation layer and the specific pattern layer are formed of the same insulating layer.

6. The device of claim 2, wherein the bridge layer is formed of a metal or transparent conductive material.

7. The device of claim 1, wherein the specific pattern layer comprises an organic or inorganic insulating material.

8. The device of claim 1, wherein the specific pattern layer comprises a transparent or colored photoresist material.

9. The device of claim 1, wherein the first thickness has a range from 0 μm to 10 μm.

10. The device of claim 1, wherein the thickness of the specific pattern layer is not greater than the second thickness.

11. A method for fabricating a touch sensing device, comprising:
providing a transparent substrate having a sensing region and a non-sensing region enclosing the sensing region;
forming a specific pattern layer on the transparent substrate in the non-sensing region, wherein the specific pattern layer has a specific pattern;
forming a shielding layer on the transparent substrate in the non-sensing region, such that the shielding layer covers the specific pattern layer and exposes the sensing region, wherein the shielding layer above the specific pattern layer has a first thickness and the shielding layer outside of the specific pattern layer has a second thickness greater than the first thickness;
forming at least one sensing unit on the transparent substrate in the sensing region, wherein the sensing unit has a set of first sensing electrodes arranged along a first direction, a set of second sensing electrodes arranged along a second direction, and a connecting portion extending between the set of first sensing electrodes; and
covering the sensing unit and the shielding layer with a passivation layer.

12. The method as claimed in claim 11, further comprising:
forming an isolation layer on the connecting portion; and
forming a bridge layer on the isolation layer along the second direction, to be electrically connected to the set of second sensing electrodes.

13. The method of claim 12, wherein the bridge layer is formed of metal.

14. The method as claimed in claim 11, further comprising:
forming a bridge layer on the transparent substrate along the second direction, to be electrically connected to the set of second sensing electrodes; and
forming an isolation layer on the bridge layer.

15. The method of claim 14, wherein the isolation layer and the specific pattern layer are formed by patterning the same insulating layer.

16. The method of claim 14, wherein the bridge layer is formed of a transparent conductive material.

17. The method of claim 11, wherein the specific pattern layer comprises an organic or inorganic insulating material.

18. The method of claim 11, wherein the specific pattern layer comprises a transparent or colored photoresist material.

19. The method of claim 11, wherein the first thickness has a range from 0 μm to 10 μm.

20. The method of claim 1, wherein the thickness of the specific pattern layer is not greater than the second thickness.
